(19) United States
(12) Patent Application Publication
(10) Pub. No.: US 2018/0316044 A1
(43) Pub. Date: Nov. 1, 2018

(54) METHOD FOR PRODUCING A SODIUM-ION BATTERY

(71) Applicant: COMMISSARIAT A L'ENERGIE ATOMIQUE ET AUX ENERGIES ALTERNATIVES, Paris (FR)

(72) Inventors: Yohann CHATILLON, Fontaine (FR); Nelly MARTIN, Miribel Les Echelles (FR)

(21) Appl. No.: 15/769,528

(22) PCT Filed: Oct. 19, 2016
(86) PCT No.: PCT/EP2016/075111

§ 371 Date: Apr. 19, 2018

(30) Foreign Application Priority Data
Oct. 21, 2015 (FR) 1560049

(51) Int. Cl. H01M 10/058; H01M 10/054; H01M 4/04; H01M 4/60; H01M 4/58; H01M 4/587; H01M 4/139

(52) U.S. Cl. CPC H01M 10/058; H01M 10/054; H01M 4/0404; H01M 4/139; H01M 4/5825; H01M 4/587; H01M 4/60

(57) ABSTRACT

A method for preparing a sodium-ion battery comprising a positive electrode and a negative electrode arranged to either side of an electrolyte, the positive electrode comprising, as the active material, a material made from sodium, the method comprising the following steps: a step of depositing a sodium salt on the surface of the positive electrode, before placing same in the battery; a step of assembling the positive electrode, the negative electrode and the electrolyte; and a step of forming a passivation layer on the surface of the negative electrode with the sodium ions from the decomposition of the sodium salt, by applying a first charge to the abovementioned assembly.

### TECHNICAL FIELD

This invention relates to a method for producing a sodium-ion battery.

Batteries of these types have for vocation to be increasingly used as a autonomous source of energy, in particular, in portable electronic equipment (such as mobile telephones, portable computers, tools), in order to progressively replace nickel-cadmium (NiCd) and nickel metal hydride (NiMH) or lithium-ion batteries. They can also be used to provide the supply of energy required for new microapplications, such as chip cards, sensors or other electromechanical systems.

In terms of their operation, sodium-ion batteries operate according to the insertion-disinsertion principle of the sodium ion.

During the discharge of the battery, the sodium disinserted from the negative electrode in ionic form Na⁺ migrates through the ionic conductor electrolyte and is inserted into the crystalline network of the active material of the positive electrode. The passage of each Na⁺ ion in the internal circuit of the battery is exactly offset by the passage of an electron in the external circuit, generating as such an electric current.

On the other hand, during the charging of the battery, the reactions taking place in the battery are the opposite reactions of discharging, namely:
the negative electrode will insert sodium into the network of the insertion material that it is comprised of;
the positive electrode will release sodium, which will be inserted into the insertion material of the negative electrode.

During the first charging cycle of the battery, when the active material of the negative electrode is brought to an insertion potential of the sodium, a portion of the sodium will react with the electrolyte on the surface of the grains of active material of the negative electrode in order to form a passivation layer on its surface. The formation of this passivation layer consumes a non-negligible quantity of sodium ions, which is materialised by an irreversible loss in the capacity of the battery (with this loss being qualified as irreversible capacity), due to the fact that the sodium ions that have reacted are no longer available for later charging/discharging cycles.

It is therefore suitable to minimise, as much as possible, this loss during the first charge, so that the energy density of the battery is as high as possible.

To do this, in prior art, two types of techniques have been proposed to overcome the aforementioned disadvantage:
presodiation techniques of the negative electrode; or
oversodiation techniques of the positive electrode.

The same problems arise for lithium batteries, for which prelithiation techniques of the negative electrode and overlithiation techniques of the positive electrode have been proposed.

With regards to prelithiation techniques of the negative electrode, mention can be made of:
so-called “in situ” techniques consisting in depositing on the negative electrode of the lithium metal (i.e. with a “0” degree of oxidation) either in the form of a metal sheet (as described in WO 1997031401) or in the form of a lithium metal powder stabilised by a protective layer (as described in Electrochemistry Communications 13 (2011) 664-667) mixed with the ink comprising the ingredients of the negative electrode (namely, the active material, the electronic conductors and an organic binder), with the insertion taking place, independently of the alternative retained, spontaneously by a corrosion phenomenon;
so-called “ex situ” techniques consisting in electrochemically prelithiating the negative electrode, by placing the latter into an assembly comprising an electrolytic bath and a counter electrode comprising lithium, these techniques make it possible to control the quantity of lithium introduced into the negative electrode but have however the disadvantage of requiring the setting up of a complex experimental assembly.

Alternatively, in prior art, overlithiation/oversodiation techniques of the positive electrode have been proposed, in particular, by adding into the composition comprising the constituent ingredients of the positive electrode, a sacrificial salt which, during the first charge, will decompose and supply the required quantity of Li/Na in order to form the passivation layer on the surface of the negative electrode.

In these techniques, note that the sacrificial salt must be able to decompose to a potential located in the potential window scanned by the positive electrode during the first charge.

Also, when the first charge is taking place, when sodium batteries are taken for example, two simultaneous electrochemical reactions generate Li⁺/Na⁺ ions, which are the disinsertion of lithium or sodium from the positive electrode and the decomposition of the sacrificial salt.

These techniques are in particular described in document US 2013/298386, which specifies that the sacrificial salt is introduced directly into the ink comprising the ingredients of the positive electrode, namely the active material, the electronic conductor, the organic binder, with the ink then being deposited onto a current collector substrate in order to form the positive electrode, whereby the sacrificial salt is distributed, randomly, in the positive electrode.

These techniques have a certain number of disadvantages, because the decomposition of the sacrificial salt can generate several phenomena:
the appearance of dead volumes at the core of the electrode, due to the decomposition of the salt, which contributes to the increase in the porosity of the electrode; and
the electronic disconnection of certain portions of the electrode that can render the active material unable to be used and inducing, as such, a loss in the capacity of the battery.

Also, in light of the above, the authors of this invention have given themselves the objective of developing a method for producing a sodium-ion battery that makes it possible to overcome the disadvantages mentioned hereinabove.

### DISCLOSURE OF THE INVENTION

As such the invention relates to a method for preparing a sodium-ion battery comprising a positive electrode and a negative electrode arranged to either side of an electrolyte, said positive electrode comprising, as the active material, an insertion material of the sodium, said method comprising the following steps:

a) a step of depositing a sodium salt on the surface of the positive electrode, before placing same in the battery;

b) a step of assembling the positive electrode, the negative electrode and the electrolyte; and

c) a step of forming a passivation layer on the surface of the negative electrode with the sodium ions from the decomposition of the sodium salt, by applying a first charge to the abovementioned assembly.

In other terms, the first charge is applied in the potential conditions that are required for the decomposition of the sodium salt, with this decomposition resulting in the release of sodium ions, which will contribute to the formation of the passivation layer on the surface of the negative electrode. Because the sodium salt supplies the sodium ions required for the formation of the passivation layer, this salt can as such be qualified as a “sacrificial salt”.

Also, the sodium ions required for the formation of the passivation layer do not come from the active material of the positive electrode. The sodium ions of the active material of the positive electrode are therefore not lost for the formation of this layer during the first charge and therefore the loss in the capacity of the battery is lesser and even zero.

Finally, applying a sodium salt on the surface of the positive electrode contrary to prior art, where the sodium salt is added to the precursor composition of the positive electrode, satisfies a certain number of advantages.

In particular, on the one hand, at the end of the first charge, the layer comprising the sodium salt is entirely decomposed in order to give the Na⁺ ions required for the formation of the passivation layer on the negative electrode, without this disorganising the internal structure of the positive electrode, with the latter, at the end of the first charge, having a structural organisation that is similar to that of a conventional electrode, in particular without there being an appearance of dead volume and loss of active material.

On the other hand, contrary to the embodiments of prior art, where the sacrificial salt is introduced directly into the precursor composition of the positive electrode and where it is necessary to include a quantity of salt greater than that required for the formation of the passivation layer due to the impossibility of controlling the placement of the grains of salt in the structure of the electrode, the method of the invention gives the possibility of using, due to the location of the sodium salt immediately on the surface of the positive electrode, solely the quantity that is sufficient for the formation of the passivation layer on the negative electrode. In this case, there is therefore no excess salt in the positive electrode after formation of the passivation layer and therefore any unnecessary material in the latter.

As mentioned hereinabove, the method of the invention comprises a step of treating the positive electrode, before placing in an assembly comprising the negative electrode and the electrolyte, with the latter able to be made to impregnate a separator, with this treatment consisting is depositing on the positive electrode (advantageously, at least on the face intended to be in contact with the electrolyte) a sodium salt, which is intended to participate in the formation of the passivation layer during the first charge of the assembly.

This step of depositing can be carried out, in particular, by an inkjet or coating technique, consisting in depositing a composition comprising sodium salt on the positive electrode, said composition able to be deposited using a nozzle.

In particular, the step of depositing can be carried out organically, for example, by means of an ink comprising the sacrificial salt (for example, NaN₃), an electronic conductor (for example, carbon black), a polymeric binder (for example, polyvinylidene fluoride) and optionally an organic solvent, for example an aprotic polar solvent, such as an N-methylpyrrolidone solvent (NMP).

As an example of sodium salt, mention can be made of salts belonging to the following categories:
sodium azides of formulas N₃A, with A corresponding to a sodium cation;
sodium ketocarboxylates, such as those having the following formulas (II) to (IV):

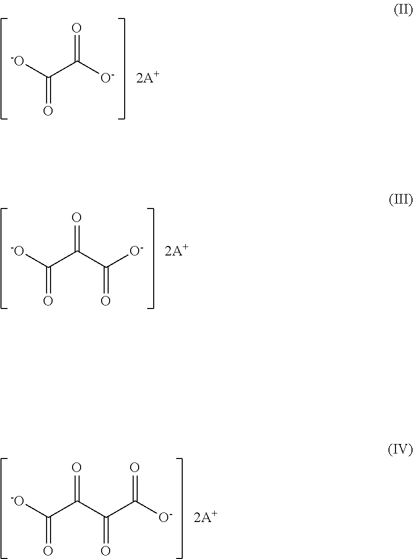

with A corresponding to a sodium cation;
sodium hydrazides, such as those having the following formulas (V) to (VI):

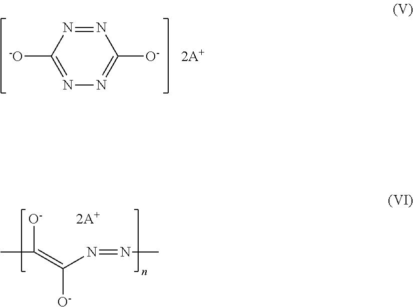

with A corresponding to a sodium cation and n corresponding to the number of repetitions of the pattern taken between brackets, with this repetition number ranging from 3 to 1000.

The positive electrode, whereon the sodium salt is deposited, comprises, as the active material, an insertion material of the sodium and this, in a reversible manner so that the charging and discharging processes can take place during the operation of the battery.

Indeed, by positive electrode, it is specified, conventionally, in the above and in what follows, that it is the electrode that acts as a cathode, when the generator is delivering current (i.e. when it is in the process of discharging) and which acts as an anode when the generator is in the charging process.

As sodium insertion materials that can form a positive electrode active material, mention can be made of:
a material of the sodium oxide type comprising at least one transition metal element;
a material of the phosphate or sodium sulphate type comprising at least one transition metal element;
a material of the sodium fluoride type; or
a material of the sulphide type comprising at least one transition metal element.

As examples of sodium oxide compounds comprising at least one transition metal element, mention can be made of simple oxides or mixed oxides (i.e. oxides comprising several separate transition metal elements) comprising at least one transition metal element, such as oxides comprising nickel, cobalt, manganese, chromium, titanium, iron and/or aluminium (with these oxides able to be mixed oxides).

More specifically, as mixed oxides comprising nickel, cobalt, manganese and/or aluminium, mention can be made of the compounds of the following formula (VII):

NaM²O₂ (VII)

wherein M² is an element chosen from Ni, Co, Mn, Al and the mixtures thereof.

As examples of such oxides, mention can be made of sodium oxides NaCoO₂, NaNiO₂ and mixed oxides Na(Ni,Co,Mn)O₂ (such as Na(Ni_{1/3}Mn_{1/3}Co_{1/3})O₂), Na(Ni,Co,Al)O₂ (such as Na(Ni_{0.8},Co_{0.15}Al_{0.05})O₂) or Na(Ni,Co,Mn,Al)O₂.

As examples of sodium phosphate compounds comprising at least one transition metal element, mention can be made of the compounds of formula NaM¹PO₄, Na₃M¹₂(PO₄)₃, Na₄M¹₃(PO₄)₂P₂O₇, where M¹ is chosen from Fe, Mn, Ni, Ti, V, Mo, Co and the mixtures thereof, such as NaFePO₄.

The material made from sodium can be, also, chosen from:
sodium fluorophosphates, such as:
fluorophosphates of formula Na₂XPO₄F, wherein X is an element chosen from Fe, Mn, Ni, Ti, V, Mo, Co and the mixtures thereof;
fluorophosphates of formula Na₃X₂(PO₄)₂F₃, wherein X is an element chosen from Fe, Mn, Ni, Ti, V, Mo, Co and the mixtures thereof (with these compounds also being designated by the abbreviation NVPF, when X corresponds to vanadium);
sodium fluorosulphates of formula NaT′SO₄F, wherein is an element chosen from Fe, Mn, Co, Ni and the mixtures thereof.

As examples of sodium fluoride compounds, mention can be made of NaFeF₃, NaMnF₃ and NaNiF₃.

Finally, as examples of sulphide compounds, mention can be made of Ni₃S₂, FeS₂ and TiS₂.

In addition to the presence of an active material, such as those defined hereinabove, the positive electrode can include a polymeric binder, such as polyvinylidene fluoride (PVDF), a carboxymethylcellulose mixture with a latex of the styrene and/or butadiene type as well as one or several electrically conductive adjuvants, which can be carbon materials such as carbon black.

As such, from a structural standpoint, the positive electrode can have the form of a composite material comprising a polymeric binder matrix, wherein are dispersed charges constituted by the active material and the electrically conductive adjuvant or adjuvants, with said composite material able to be deposited on a current collector.

Once the positive electrode treated by a sodium salt, it is assembled with a negative electrode and the electrolyte in such a way as to form the electrochemical cell of the sodium-ion battery.

It is specified that the term negative electrode means, conventionally, in the above and in what follows, the electrode that acts as an anode, when the generator is delivering current (i.e. when it is in the discharging process) and which acts as a cathode, when the generator is in the charging process.

Conventionally, the negative electrode comprises, as the active electrode material, a material that is able to insert, in a reversible manner, sodium.

In particular, the negative electrode active material can be:
a carbon material, such as hard carbon, natural or artificial graphite;
a sodium alloy, such as a silicon-sodium alloy, a tin-sodium alloy, a lead-sodium alloy, an antimony-sodium alloy;
a mixed sodium oxide, such as Na₄Ti₅O₁₂, NaTiO₂, a sodium and aluminium titanate.

Furthermore, in the same way as for the positive electrode, the negative electrode can comprise a polymeric binder, such as polyvinylidene fluoride (PVDF), a carboxymethylcellulose mixture with a latex of the styrene and/or butadiene type as well as one or several electrically conductive adjuvants, which can be carbon materials, such as carbon black. Furthermore, in the same way as for the positive electrode, the negative electrode can have, from a structural standpoint, as a composite material comprising a polymeric binder matrix wherein are dispersed charges constituted by the active material (having, for example, a particulate form) and optionally the electrically conductive adjuvant or adjuvants, with said composite material able to be deposited on a current collector.

The electrolyte is a sodium ion conductive electrolyte according to the destination of the battery, and can be, in particular:
a liquid electrolyte comprising a sodium salt dissolved in an organic solvent, such as an aprotic apolar solvent;
an ionic liquid; or
a polymer solid electrolyte.

As examples of sodium salt, mention can be made of NaClO₄, NaAsF₆, NaPF₆, NaBF₄, NaRfSO₃, NaCH₃SO₃, NaN(RfSO₂)₂, Rf being chosen from F or a perfluoroalkyl group comprising from 1 to 8 carbon atoms, sodium trifluoromethanesulfonylimide, sodium bis(oxalato)borate, sodium bis(perfluorethylsulfonyl)imide, sodium fluoroalkylphosphate.

As examples of organic solvents that can be part of the constitution of the abovementioned electrolyte, mention can be made of carbonate solvents, such as cyclic carbonate solvents, linear carbonate solvents and the mixtures thereof.

As examples of cyclic carbonate solvents, mention can be made of ethylene carbonate (symbolised by the abbreviation EC), propylene carbonate (symbolised by the abbreviation PC).

As examples of linear carbonate solvents, mention can be made of dimethyl carbonate, diethyl carbonate (symbolised by the abbreviation DEC), dimethyl carbonate (symbolised by the abbreviation DMC), ethylmethyl carbonate (symbolised by the abbreviation EMC).

Furthermore, the electrolyte, in particular when it is a liquid electrolyte, can be made to soak a separating element, for example, a porous polymeric separating element, arranged between the two electrodes of the battery.

The assembly obtained as such is then subjected, in accordance with the invention, to a step of a first charge in the potential conditions that are required for the decomposition of the sodium salt deposited on the surface of the positive electrode, with the decomposition being materialised by the release of sodium ions, which will participate in the formation of the passivation layer.

Also, from a practical standpoint, it is understood that the sodium salt must be able to decompose at a potential window that will be scanned by the positive electrode during the first charge.

As such, during the implementation of the first charge, in addition to the fact that the battery is charging, a decomposition reaction of the sodium salt also results. During this reaction, the sodium salt produces sodium ions that pass into the electrolyte and react with the latter in order to form the passivation layer on particles of active material of the negative electrode. In addition to the release of sodium ions, the decomposition of the salt results in the production of a small quantity of gaseous compounds. The latter can be soluble in the electrolyte and can, if needed, be removed during a step of degassing.

Other characteristics and advantages of the invention shall appear in the following description supplement and which relates to particular embodiments.

Of course, this description supplement is provided only as an illustration of the invention and does not form in any way a limitation of it.

### BRIEF DESCRIPTION OF THE DRAWINGS

FIG. 1 is a graph showing the change in the capacity C (in mAh/g) according to the number of cycles N, with the results for the first battery, the second battery and the third battery of the concrete embodiment being respectively shown by curves a), b) and c).

FIG. 2 is a graph showing the relative gain G (in %) according to the number of cycles N respectively of the first battery and of the second battery according to the third battery, with these results being plotted on the curve a for the first battery and the curve b for the second battery.

### DETAILED DISCLOSURE OF PARTICULAR EMBODIMENTS

These embodiments show the preparation of a sodium-ion battery in accordance with the invention and of two sodium-ion batteries that are not in accordance with the invention, namely:
a first battery prepared in accordance with the method of the invention, of which the positive electrode is coated prior to the assembly of a sodium salt (NaN₃);
a second battery similar to the first battery, if only that the positive electrode is prepared using an ink comprising, in addition to the conventional ingredients, already a sodium salt (NaN₃); and
a third battery similar to the first battery, if only that the positive electrode does not comprise sodium salt (NaN₃).

For the first battery, the positive electrode is obtained, by coating, on a current collector made of aluminium with a thickness of 20 μm, of an ink comprising 92% by weight of a sodium fluorophosphate Na₃V₂(PO₄)₂F₃, 4% by weight of an electronic conductor of the carbon black type (Super C65 TIMCAL) and 4% by weight of a polymeric binder of the vinylidene polyfluoride type (solubilised in N-methylpyrrolidone).

The coating of the ink on the collector leads to the formation of a layer with a thickness of about 200 The resulting product is then placed in an extraction oven at a temperature of 50° C. for 12 hours, so that the residual water and the N-methylpyrrolidone evaporate. Once dry, the product is cut into the form of pellets with a diameter of 14 mm, which as such form circular electrodes. These electrodes are then calandered (3.25 T/cm² for 10 seconds) using a press in order to reduce the porosity thereof.

The negative electrode is obtained by coating, on a current collector made of aluminium 20 μm thick, with an ink containing 92% by weight of hard carbon, 4% by weight of an electronic conductor of the carbon black type (Super C65 TIMCAL) and 4% by weight of a polymeric binder of the vinylidene polyfluoride type (solubilised in the N-methylpyrrolidone).

The coating of the ink on the collector leads to the formation of a layer with a thickness of about 100 μm. The resulting product is then placed in an extraction oven at a temperature of 50° C. for 12 hours, so that the residual water and the N-methylpyrrolidone evaporate. Once dry, the product is cut into the form of pellets with a diameter of 16 mm, which as such form circular electrodes. These electrodes are then calandered (2.5 T/cm² for 10 seconds) using a press in order to reduce the porosity thereof.

Before assembly, the positive electrode is treated, by depositing on the face intended to be in contact with the electrolyte, an ink containing 90% by weight of sodium azide NaN₃, 5% by weight of an electronic conductor of the carbon black type (Super C65 TIMCAL) and 5% by weight of a polymeric binder of the vinylidene polyfluoride type (solubilised in N-methylpyrrolidone), whereby 3.5 mg of NaN₃ are deposited.

Once the positive electrode is treated as such, it is placed with the negative electrode to either side of a separator soaked with electrolyte comprising a mixture of carbonate solvents (ethylene carbonate/dimethyl carbonate) 50:50 with a sodium salt NaPF₆ (1 mol/L).

For the second battery, the latter is prepared, similarly to the first battery, if only that the positive electrode is prepared, by coating, on a current collector made of aluminium with a thickness of 20 μm, with an ink containing 69% by weight of a sodium fluorophosphate of Na₃V₂(PO₄)₂F₃, 3.8% by weight of an electronic conductor of the carbon black type (Super C65 TIMCAL), 3.8% by weight of a polymeric binder of the vinylidene polyfluoride type (solubilised in N-methylpyrrolidone) and 23.4% by weight of NaN₃, whereby the positive electrode contains 3.5 mg of NaN₃.

For the third battery, the latter is prepared similarly to the first battery, if only that the positive electrode is not subjected to a surface treatment with a solution containing sodium azide and that the positive electrode does not contain sodium salt (NaN₃).

The first battery, the second battery and the third battery are subjected to cycling tests at a speed C/20.

More specifically, a constant positive current is imposed on the batteries until their voltage reaches 4.3 V (which corresponds to the first charge phase). Then, a negative current is imposed until 2 V (which corresponds to the first discharge phase). The chaining of these two phases forms a charge/discharge cycle, which is repeated 5 times.

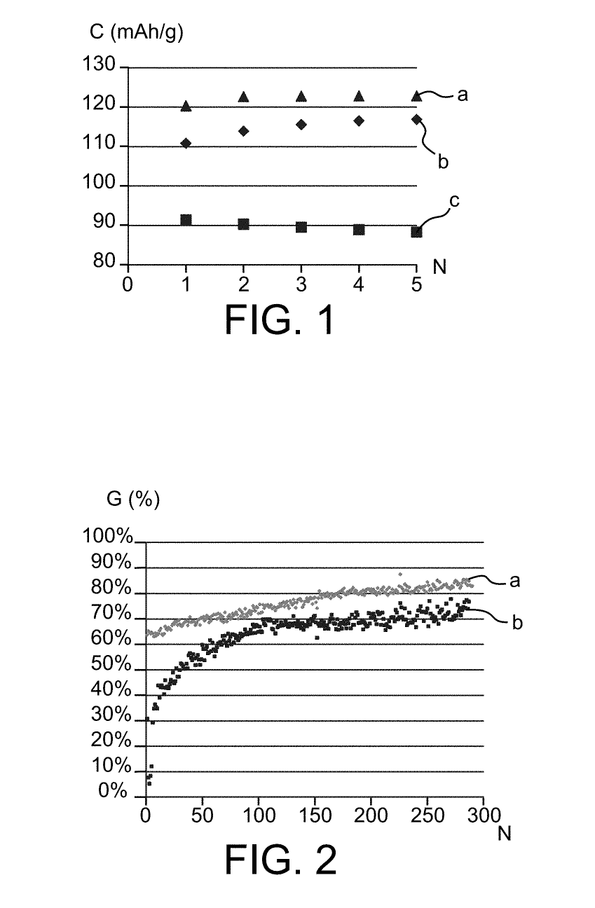

At the end of each test, the capacity of the batteries (expressed in mAh/g) is measured, with the values of the capacity being reported in FIG. 1, showing the change in the capacity C (in mAh/g) according to the number of cycles N, with the results for the first battery, the second battery and the third battery being respectively shown by the curves a), b) and c).

This results, in FIG. 1, that the first battery has the best results. This can be explained by the fact that, during the first charge, the passivation layer is formed thanks to the sodium ions coming from the decomposition of the sodium salt added on the surface of the electrode and not on the sodium ions coming from the active material and/or the core of the material of the electrode.

With respect to the second battery, the results are better, as all of the salt required for the formation of the passivation layer has been decomposed while, for the second battery, a portion of this salt is not electrochemically active and therefore lost.

For this first battery, the physical integrity of the positive electrode is intact after the first charge and the sodium of the active material is not used in part for the formation of the passivation layer, giving better results in terms of capacity.

The three batteries are also subjected to discharge power tests with a discharge at different currents (from C/20 to 10 C) and a systematic recharge at C/10. The best results are obtained with the first battery for discharge speeds ranging from 5 C to 10 C.

Finally, cycling tests at 1 C were conducted with the three batteries, consisting in charging them and discharging them alternatively at a constant current 1 C.

The results were used by determining the relative gain G (in %) corresponding for a given battery to the following formula:

G=[Cₙ−C₃]/C₃

wherein Cₙ corresponds to the capacity of the battery n and C₃ corresponds to the capacity of the third battery,

according to the number of cycles N respectively of the first battery and of the second battery according to the third battery, these results were reported in FIG. 2 (curve a for the first battery and curve b for the second battery).

For the two curves, an increase in the gain according to the number of cycles is observed, which attests the beneficial nature of the presence of the salt in the positive electrode with still a gain that is higher for the first battery, with the difference located at about 10% starting with 100 cycles, which attests the better cycling performance for the first battery.

1-9. (canceled)

10. Method for preparing a sodium-ion battery comprising a positive electrode and a negative electrode arranged to either side of an electrolyte, said positive electrode comprising, as the active material, a material made from sodium, said method comprising the following steps:
a) a step of depositing a sodium salt on the surface of the positive electrode, before placing same in the battery;
b) a step of assembling the positive electrode, the negative electrode and the electrolyte; and
c) a step of forming a passivation layer on the surface of the negative electrode with the sodium ions from the decomposition of the sodium salt, by applying a first charge to the abovementioned assembly.

11. Method according to claim 10, wherein the step of depositing is carried out by an inkjet or coating technique, consisting in depositing a composition comprising sodium salt on the positive electrode.

12. Method as claimed in claim 10, wherein the sodium salt is chosen from:
sodium azides of formula N₃A, with A corresponding to a sodium cation;
sodium ketocarboxylates, such as those having the following formulas (II) to (IV): 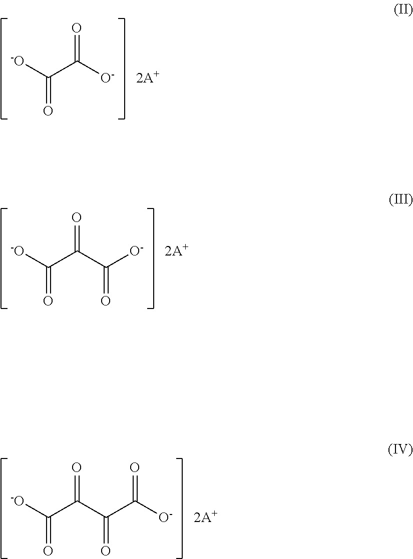
with A corresponding to a sodium cation;
sodium hydrazides, such as those having the following formulas (V) to (VI): 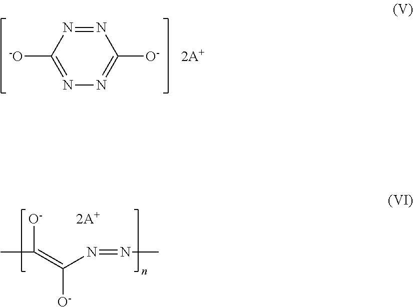
with A corresponding to a sodium cation and n corresponding to the number of repetitions of the pattern taken between brackets.

13. Method according to claim 10, wherein the sodium salt is a sodium azide having formula N₃A, with A corresponding to a sodium cation.

14. Method according to claim 10, wherein the positive electrode comprises, as the active material:
a material of the sodium oxide type comprising at least one transition metal element;
a material of the phosphate or sodium sulphate type comprising at least one transition metal element;
a material of the sodium fluoride type; or
a material of the sulphide type comprising at least one transition metal element.

15. Method according to claim 10, wherein the positive electrode comprises, as the active material, a material chosen from sodium fluorophosphates.

16. Method according to claim 10, wherein the positive electrode comprises, as the active material, a material chosen from fluorophosphates of formula Na₃X₂(PO₄)₂F₃, wherein X is an element chosen from Fe, Mn, Ni, Ti, V, Mo Co and the mixtures thereof.

17. Method according to claim 10, wherein the negative electrode comprises, as the active material:
a carbon material, such as hard carbon, natural or artificial graphite;
a sodium alloy, such as a silicon-sodium alloy, a tin-sodium alloy, a lead-sodium alloy; or
a mixed sodium oxide, such as Na₄Ti₅O₁₂ or NaTiO₂, a sodium and aluminium titanate.

18. Method according to claim 10, wherein the negative electrode comprises, as the active material, hard carbon.
